(19) United States
(12) Patent Application Publication
(10) Pub. No.: US 2012/0062467 A1
(43) Pub. Date: Mar. 15, 2012

(54) ELECTRONIC SYSTEM, METHOD FOR CONTROLLING MOBILE APPARATUS, READING APPARATUS AND METHOD FOR CONTORLLING THEREOF

(75) Inventor: Gwo-Feng HWANG, Hsinchu (TW)

(73) Assignee: E Ink Holdings Inc., Hsinchu City (TW)

(21) Appl. No.: 13/085,228

(22) Filed: Apr. 12, 2011

(30) Foreign Application Priority Data
Sep. 10, 2010 (TW) 099130700

(51) Int. Cl. G06F 3/02; G06F 3/041

(52) U.S. Cl. 345/169; 345/173

(57) ABSTRACT

An electronic system includes a mobile apparatus and a reading apparatus. The mobile apparatus includes a first screen for showing a display image. Similarly, the reading apparatus includes a second screen, which is a touch control screen. When the reading apparatus links with the mobile apparatus through a data transmission interface, the mobile apparatus transmits the display image to the reading apparatus, so that the display image is displayed on the second screen of the reading apparatus. In addition, when an operation motion is performed on the second screen, a corresponding sensing signal generated by the reading apparatus is transmitted to the mobile apparatus, and the mobile apparatus determines whether or not responding to the operation motion according to the sensing signal.

### FIELD OF THE INVENTION

The present invention generally relates to electronic systems, and more particularly to an electronic system for reading an electronic document.

### BACKGROUND OF THE INVENTION

With development of the semiconductor process, the display production, the industrial design and the communication technology, a mobile apparatus trends to has a thinner structure and more powerful function. The mobile apparatus generally is an apparatus with an operation processing function, such as a mobile phone, a smart phone, a personal digital assistant (PDA) and a pocket personal computer (PC).

At present, the mobile apparatus has not only functions of calendar, recording notes, transceiver a message or making a call, but also has additional functions such as wireless internet access, games and e-book reader. Take an e-book reader as an example, due to the mobile apparatus is thin and light, a user can read e-books whenever and wherever possible only by storing several e-books in the mobile apparatus. In addition, the user also can edit on the mobile apparatus.

Generally, a lighter and thinner mobile apparatus is better, thus, the size of a screen of the mobile apparatus usually is not big. In present market, mainstream sizes of the screen of the mobile apparatus can be 3.2 inches, 3.5 inches and 3.7 inches. If the user uses the mobile apparatus for editing a calendar, it is satisfied enough with the mainstream sizes. However, if the user uses the mobile apparatus for reading e-books, the screen with mainstream sizes can be used with difficulty.

### SUMMARY OF THE INVENTION

Therefore, the present invention provides an electronic system, which can be used for a user reading an electronic document in a comfortable way.

The present invention further provides a reading apparatus, which can be used for a user reading an electronic document on the mobile apparatus.

The present invention also provides a method for controlling the reading apparatus, which can make an electronic document in the mobile apparatus displayed by the reading apparatus, such that a user can read the electronic document.

In addition, the present invention further provides a method for controlling the mobile apparatus, which can be used for a user reading an electronic document by operating the mobile apparatus.

An electronic system provided by the present invention comprises a mobile apparatus and a reading apparatus. The mobile apparatus has a first screen for showing a display image. Similarly, the reading apparatus has a second screen, which is a touch control screen. When the reading apparatus links with the mobile apparatus through a data transmission interface, the mobile apparatus transmits the display image to the reading apparatus, so that the display image is displayed on the second screen of the reading apparatus. In addition, when an operation motion is performed on the second screen, a corresponding sensing signal generated by the reading apparatus is transmitted to the mobile apparatus, and the mobile apparatus determines whether or not responding to the operation motion according to the sensing signal.

In one embodiment of the present invention, a size of the first screen is smaller than a size of the second screen.

From another viewpoint, a reading apparatus provided by the present invention comprises a transceiver module, a screen and a detection unit. The transceiver module transmits and receives data through a data transmission interface. A plurality of touch units is disposed in the screen. The detection unit detects a status of each of the touch units, and generates a corresponding sensing signal, when any of the touch units is touched. When the reading apparatus links with a mobile apparatus through the data transmission interface, the reading apparatus enters an extended screen mode, such that the mobile apparatus obtains a mastership of the reading apparatus. Then, the transceiver module receives a display image from the mobile apparatus through the data transmission interface, and transmits the display image to the screen for display. The sensing signal is transmitted to the mobile apparatus by the transceiver module through the data transmission interface, such as the mobile apparatus determines whether or not responding to the operation motion according to the sensing signal.

In one embodiment of the present invention, the data transmission includes a universal serial bus transmission interface, a Bluetooth transmission interface and an infrared-ray transmission interface.

From another viewpoint, a method for controlling the reading apparatus provided by the present invention comprises detecting the reading apparatus whether or not linking with a mobile apparatus through a data transmission interface, wherein the reading apparatus has a touch control screen. When the reading apparatus links with the mobile apparatus through the data transmission interface, the mobile apparatus obtains a display image. The display image is originally displayed on the screen of the mobile apparatus. The display image is then displayed on the screen of the reading apparatus. In addition, when an operation motion is performed on the touch control screen, a corresponding sensing signal generated by the reading apparatus is transmitted to the mobile apparatus, and the mobile apparatus determines whether or not responding to the operation motion according to the sensing signal.

From another viewpoint, a method for controlling a mobile apparatus provided by the present invention comprises detecting the mobile apparatus whether or not linking with a reading apparatus through a data transmission interface, wherein the reading apparatus includes a touch control screen. When the mobile apparatus links with the reading apparatus through the data transmission interface, the mobile apparatus obtains a mastership of the reading apparatus. Thus, the display image original displayed on the screen of the mobile apparatus is transmitted to the reading apparatus through the data transmission interface, so that the display image is displayed on the screen by the reading apparatus. Otherwise, the method also includes sensing the reading apparatus whether or not generating a corresponding sensing signal resulted from an operation motion on the touch control screen being performed. Thus, when an operation motion is performed on the touch control screen, a corresponding sensing signal is acquired for the mobile apparatus determining whether or not responding to the operation motion.

In the present invention, the mobile apparatus can acquire the mastership of the reading apparatus, so as to make the display image originally displayed on the mobile apparatus being displayed on the reading apparatus, and the mobile apparatus can respond to the operation motion performed on the reading apparatus. Therefore, the present invention can be used for a user reading an electronic document in a comfortable way.

For above and another objectives, features, and advantages of the present invention being better understood and legibly, accompanying embodiments together with the drawings are particularized . . . .

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a block diagram of an electronic system according to an embodiment of the present invention;

FIG. 2 is a block diagram of a mobile system according to an embodiment of the present invention;

FIG. 3 is a block diagram of a reading apparatus according to an embodiment of the present invention;

FIG. 4 is a block diagram of a reading apparatus according to another embodiment of the present invention;

FIG. 5 is a flow chart of a method for controlling the reading apparatus according to an embodiment of the present invention; and

FIG. 6 is a flow chart of a method for controlling the mobile apparatus according to an embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

A main technology of the present invention is completed through a reading apparatus linking with a mobile apparatus as an extended screen of the mobile apparatus. Therefore, a user can conveniently read and further edit an electronic document such as an e-book.

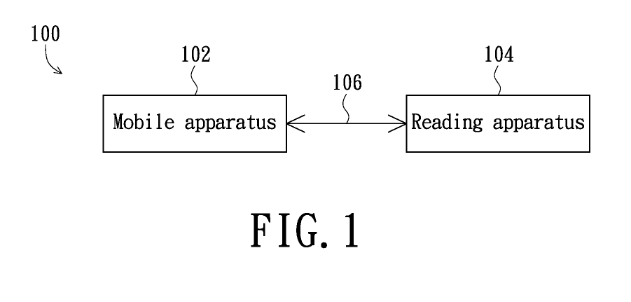

FIG. 1 is a block diagram of an electronic system according to an embodiment of the present invention. Referring to FIG. 1, in the embodiment, an electronic system 100 comprises a mobile apparatus 102 and a reading apparatus 104. The mobile apparatus 102 can be a mobile phone, a smart phone, a PDA or a pocket computer. Otherwise, the mobile apparatus 102 links with the reading apparatus 104 through a data transmission interface 106. In an embodiment, the data transmission interface 106 can be a wired interface, such as a Universal Serial Bus (USB) transmission interface. In another embodiment, the data transmission interface 106 can also be a wireless interface, such as a Bluetooth transmission interface and an infrared-ray transmission interface.

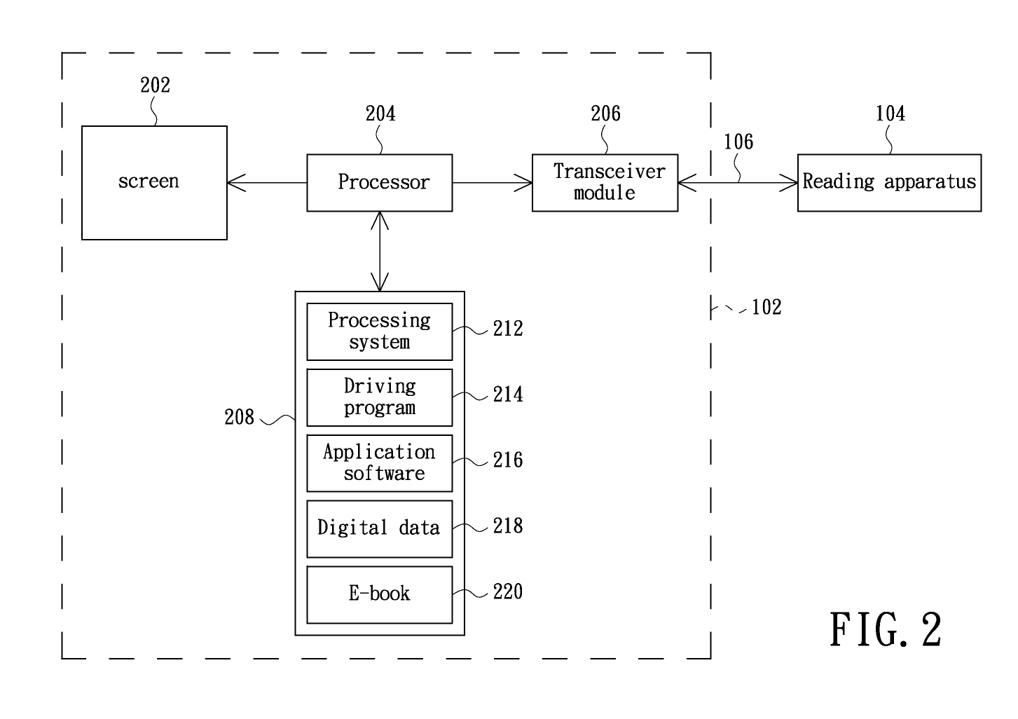

FIG. 2 is a block diagram of a mobile system according to an embodiment of the present invention. Referring to FIG. 2, a mobile system 102 comprises a screen 202, a processor 204, a transceiver module 206 and a storage unit 208. The processor 204 is coupled to the screen 202, the transceiver module 206 and the storage unit 208. Otherwise, the transceiver module 206 links with the reading apparatus 104 through the data transmission interface 106.

The storage unit 208 can be an electro-volatile memory, such as a flash memory. The storage unit 208 can also be a hard disk. In another embodiment, the storage unit 208 can also be a memory card. A processing system 212, a driving program 214 and an application software 216 can be installed in the storage unit 208. Otherwise, the storage unit 208 can store some digital data 218 therein. In another embodiment, the storage unit 208 can also store an electronic document therein, such as an e-book 220.

When the mobile apparatus 102 is operated, the processor 204 accesses data from the storage unit 208, and a display image is displayed on the screen 202. Particularly, when the mobile apparatus 102 links with the reading apparatus 104 through the data transmission interface 106, the processor 204 obtains a mastership of the reading apparatus 104. Then, the processor 204 transmits the display image originally displayed on the screen 202 to the transceiver module 206, and the transceiver module 206 further transmits the display image to the reading apparatus 104 through the data transmission interface 106.

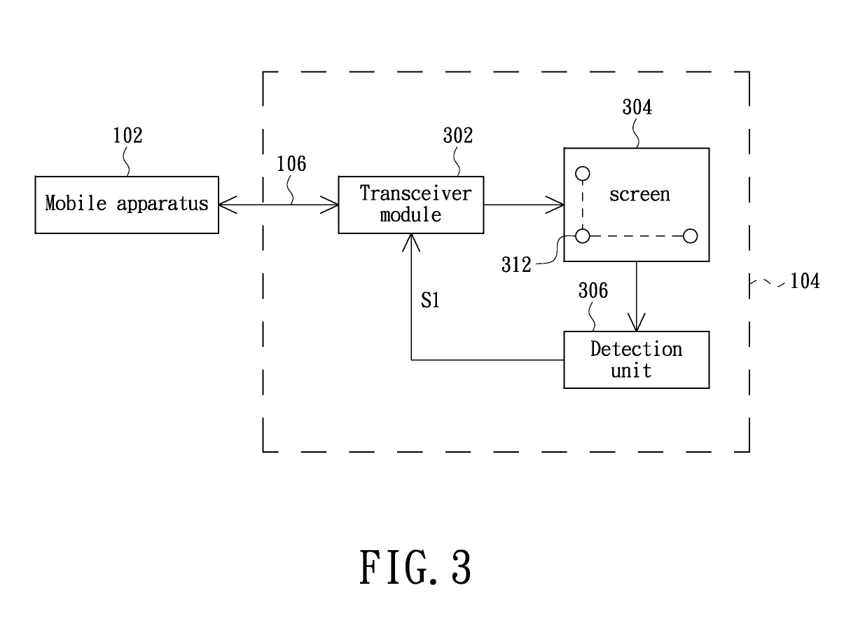

FIG. 3 is a block diagram of a reading apparatus according to an embodiment of the present invention. Referring to FIG. 3, in the embodiment, the reading apparatus 104 includes a transceiver module 302 and a screen 304. The transceiver module 302 is coupled to the data transmission interface 106, and is further coupled to the screen 304.

Together referring to FIGS. 2 and 3, when the mobile apparatus 102 links with the reading apparatus 104, the reading apparatus 104 enters an extended screen mode. A mastership of the reading apparatus 104 is delivered to the mobile apparatus 102. Thus, the display image original displayed on the screen 202 of the mobile apparatus 102 is transmitted to the reading apparatus 104 through the data transmission interface 106. The transceiver module 302 receives the display image through the data transmission interface 106, and is further transmits the display image to the screen 304. Thus, the display image original displayed on the screen 202 of the mobile apparatus 102 is displayed on the screen 304 of the reading apparatus 104.

The screen 304 can be a bistable display, such as an electrophoretic display. A character of the display of this type is that it still can display an image when powered off. Thus, if the user uses the reading apparatus 104 for displaying the display image of the mobile apparatus 102, especially for displaying some electronic document, such as the e-book 220, power consumption can be reduced. The size of the screen 304, for example, 10 inches, is larger than the size of the screen 202. Therefore, the user can read an electronic document in a comfortable way.

A plurality of touch units 312 is further disposed on the screen 304. Thus, the screen 304 is a touch control screen. In the embodiment, the plurality of touch units 312 can be a resistance touch element or a capacity touch element. The reading apparatus 104 further includes a detection unit 306 coupled to the screen 304. The detection unit 304 is used for sensing a status of each of the touch units 312, and detecting if any of the touch units is touched. When one of the touch units 312 is touched, the detection unit 306 generates a corresponding sensing signal S1 to the transceiver module 302. The transceiver module 302 transmits the sensing signal S1 to the mobile apparatus 102 through the data transmission interface 106.

When the sensing signal S1 is transmitted to the mobile apparatus 102 through the data transmission interface 106, the transceiver module 206 receives the sensing signal S1, and transmits the sensing signal S1 to the processor 204. The processor 204 determines whether or not responding to the operation motion on the reading apparatus 104 according to the sensing signal S1. For example, when the user reads an e-book on the reading apparatus 104 and touches an area of the display image on the screen 304 corresponding to “turn to next page” operation, the processor 204 of the mobile apparatus 102 responds to the operation motion by transmitting a display image next to the current read page of the e-book to the reading apparatus 104, so as to complete an operation motion of “turn to next page”.

Based on above description, the mastership of the reading apparatus 104 belongs to the mobile apparatus 102, thus, the reading apparatus 104 can display a display image on the screen 304 without an operation processing function. However, it doesn't mean that the reading apparatus 104 is limited to have no operation processing function. In another embodiment, the reading apparatus 104 can also has some simple operation processing function.

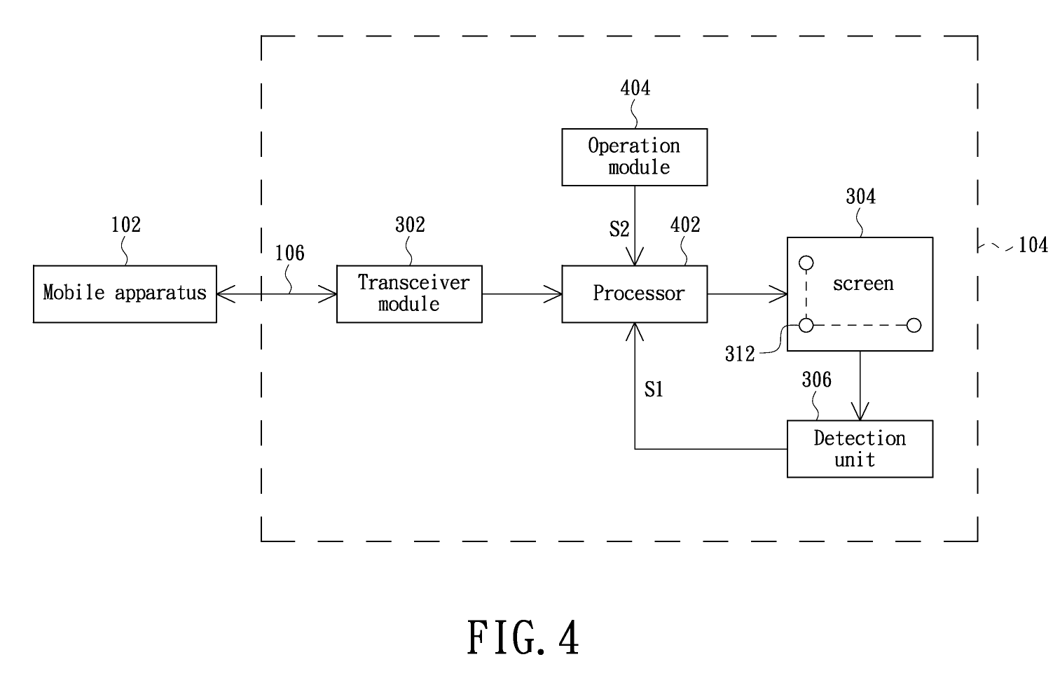

FIG. 4 is a block diagram of a reading apparatus according to another embodiment of the present invention. Referring to FIG. 4, in the embodiment, the reading apparatus 104 further includes a processor 402, which is coupled to the transceiver module 302, the screen 304 and the detection unit 306. In another embodiment, the reading apparatus 104 further includes an operation module 404 coupled to the processor 402. The operation module 404 includes a plurality of operation units (not shown), such as a plurality of solid buttons. When one of the solid buttons is enabled, the operation module 404 generates a corresponding sensing signal S2 to the processor 402 for processing.

It should be understood by one skilled in the art, the operation module 404 can also be disposed in the reading apparatus 104 described in the embodiment shown in FIG. 3. In the embodiment, the operation module 404 is directly coupled to the transceiver module 302. When one of the operation units of the operation module 404 is enabled, the operation module 404 generates a corresponding operation signal S2 to the transceiver module 302. The transceiver module 302 transmits the operation signal S2 to the mobile apparatus 102 through the data transmission interface 106.

Further referring to FIG. 4, when the reading apparatus 104 does not link with the mobile apparatus 102, the processor 402 can manage the operation of the reading apparatus 104, such as operating responding to the sensing signal S1 or the operation signal S2. However, when the reading apparatus 104 links with the mobile apparatus 102, the reading apparatus 104 enters an extended screen mode. Thus, the processor 402 is set in an idle state. Then, all the data to be processed transmitted to the processor 402, such as the sensing signal S1 and the operation signal S2, should be transmitted to the transceiver module 302, and further transmitted to the mobile apparatus 102 through the data transmission interface 106 for being processed by the mobile apparatus 102.

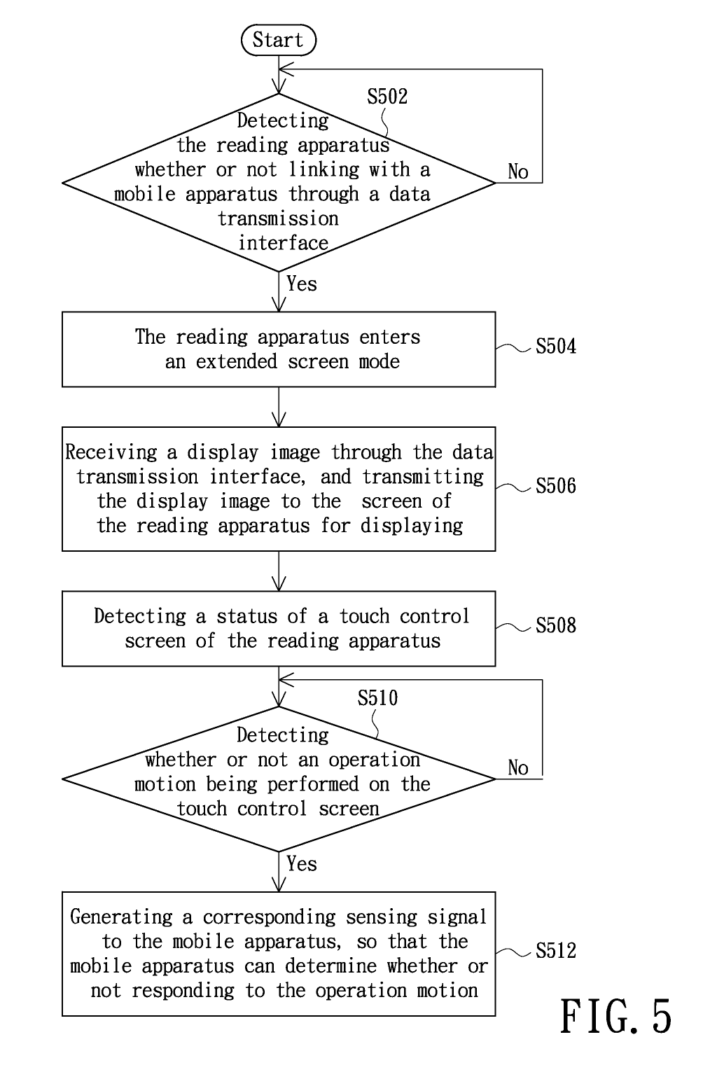

FIG. 5 is a flow chart of a method for controlling the reading apparatus according to an embodiment of the present invention. Referring to FIG. 5, in the embodiment, the method can be implemented by software, and can be written into the processor 402 or the transceiver module 302 of the reading apparatus 104. The method in the embodiment can be first implemented by the step S502, sensing the reading apparatus whether or not link with a mobile apparatus (for example, the mobile apparatus 102 shown in FIG. 1) through a data transmission interface (for example, the data transmission interface 106 shown in FIG. 1).

When the reading apparatus links with the mobile apparatus through the data transmission interface (that is, “Yes” labeled by S502), the step S504 is enabled that the reading apparatus enters an extended screen mode. Then, in the step S506, receiving a display image through the data transmission interface, and transmitting the display image to the screen of the reading apparatus for display. The display image is originally displayed on the screen of the mobile apparatus. The method in the embodiment further includes a step S508 of sensing a status of a touch control screen of the reading apparatus. Then, turn into the step S510, determining if a operation motion is performed on the touch control screen. When an operation motion is performed on the touch control screen (that is, “Yes” labeled by S502), turn into the step S512, generating a sensing signal corresponding to the performed operation motion, and transmitting the sensing signal to the mobile apparatus through the data transmission interface, so that the mobile apparatus can determine whether or not responding to the operation motion.

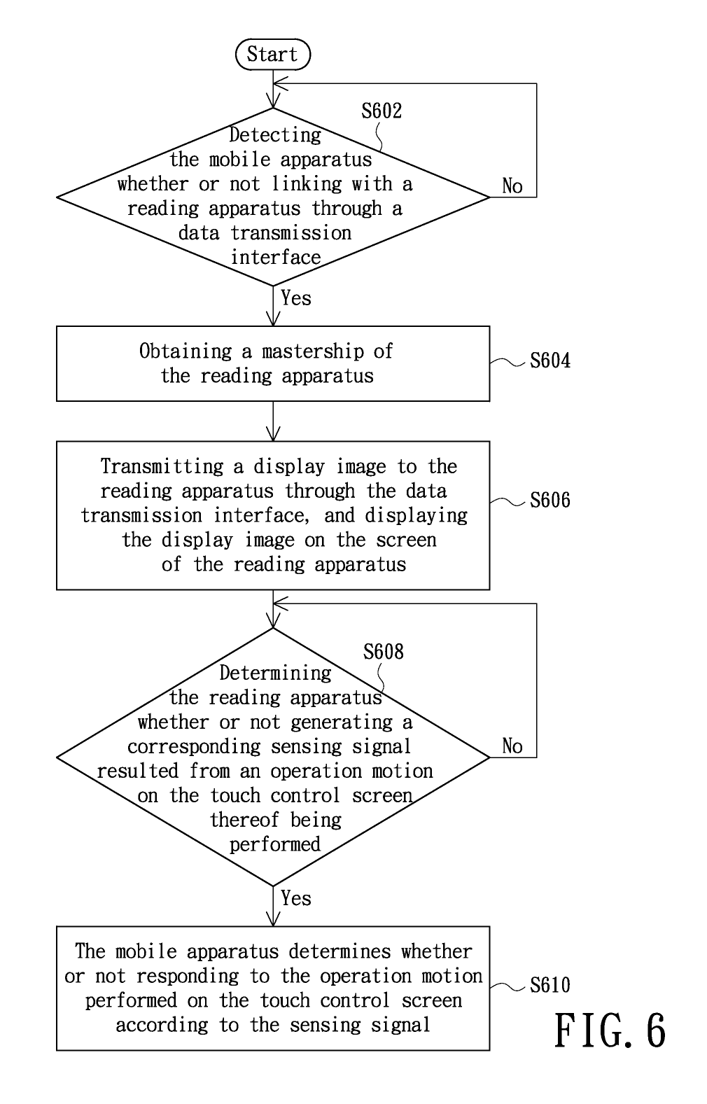

FIG. 6 is a flow chart of a method for controlling the mobile apparatus according to an embodiment of the present invention. Referring to FIG. 6, in the embodiment, the method can be implemented in the manner of the application software 216 shown in FIG. 2. In another embodiment, the method can be implemented in form of a firmware written in the processor 204 shown in FIG. 2.

The method in the embodiment can be first implemented by the step S602, sensing the mobile apparatus whether or not link with a reading apparatus (for example, the reading apparatus 104 shown in FIG. 1) through a data transmission interface (for example, the data transmission interface 106 shown in FIG. 1). When the mobile apparatus links with the reading apparatus through the data transmission interface (that is, “Yes” labeled by S602), the step S604 is enabled that acquiring a mastership of the reading apparatus. And, in the step S606, transmitting a display image to the reading apparatus through the data transmission interface, so that the display image is displayed on the screen of the reading apparatus. The display image is originally displayed on the screen of the mobile apparatus.

In the step S608, determining the reading apparatus whether or not generate a corresponding sensing signal resulted from an operation motion on the touch control screen thereof being performed. When an operation motion is performed on the touch control screen (that is, “Yes” labeled by S608), the step S610 is enabled that the sensing signal is based on for the mobile apparatus determining whether or not responding to the operation motion performed on the touch control screen.

As stated above, in the present invention, the reading apparatus is linked with the mobile apparatus through the data transmission interface, and the mobile apparatus can acquire the mastership of the reading apparatus, so as to make the display image originally displayed on the mobile apparatus being displayed on the reading apparatus. Therefore, the user can read an electronic document in a comfortable way.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electronic system, comprising:
a mobile apparatus, having a first screen for showing a display image; and
a reading apparatus, having a second screen, which is a touch control screen;
wherein when the reading apparatus links with the mobile apparatus through a data transmission interface, the mobile apparatus transmits the display image to the reading apparatus, so as to show the display image on the second screen of the reading apparatus, and
when an operation motion is performed on the second screen, a corresponding sensing signal is generated by the reading apparatus being transmitted to the mobile apparatus, so that the mobile apparatus responds to the operation motion according to the sensing signal.

2. The electronic system as claimed in claim 1, wherein the mobile apparatus is a personal digital assistant, a pocket computer, a mobile phone or a smart phone.

3. The electronic system as claimed in claim 1, wherein the mobile apparatus comprising:
a transceiver module, linking with the reading apparatus through the data transmission interface; and
a processor, coupled to the transceiver module, for transmitting the display image to the reading apparatus through the transceiver module, and receiving the sensing signal, so as to respond to the operation motion through the transceiver.

4. The electronic system as claimed in claim 3, wherein the mobile apparatus further comprises a storage unit coupled to the processor.

5. The electronic system as claimed in claim 4, wherein the storage unit is a memory card.

6. The electronic system as claimed in claim 1, wherein the second screen is an electrophoretic screen.

7. The electronic system as claimed in claim 1, wherein the data transmission interface includes a universal serial bus transmission interface, a Bluetooth transmission interface and an infrared-ray transmission interface.

8. The electronic system as claimed in claim 1, wherein a size of the first screen is smaller than a size of the second screen.

9. A reading apparatus, comprising:
a transceiver module, for transmitting and receiving data through a data transmission interface;
a screen;
a plurality of touch unit, disposed on the screen; and
a detection unit, for sensing a status of each of the touch units and generating a corresponding sensing signal when any of the touch units being touched;
wherein when the reading apparatus links with a mobile apparatus through the data transmission interface, the reading apparatus enters an extended screen mode, such that the mobile apparatus obtains a mastership of the reading apparatus, and the transceiver module receives a display image from the mobile apparatus through the data transmission interface, so as to transmit the display image to the screen for displaying, and
the transceiver module transmits the sensing signal to the mobile apparatus through the data transmission interface, so that the mobile apparatus determining whether or not responding to the sensing signal.

10. The reading apparatus as claimed in claim 9, wherein the screen is an electrophoretic screen.

11. The reading apparatus as claimed in claim 9, further comprising an operation module coupled to the transceiver module, wherein the operation module has a plurality of operation units.

12. The reading apparatus as claimed in claim 11, wherein the plurality of operation units comprise a plurality of solid buttons, when one of the solid buttons is enabled, the operation module generates a corresponding sensing signal.

13. The reading apparatus as claimed in claim 9, further comprising a processor coupled to the screen, the detection unit and the transceiver module, when the reading apparatus entering the extended screen mode, the processor enters an idle state.

14. The reading apparatus as claimed in claim 13, further comprising an operation module coupled to the processor, the operation module including a plurality of operation unit.

15. The reading apparatus as claimed in claim 14, wherein the plurality of operation units include a plurality of solid buttons, when one of the solid buttons is enabled, the operation module generates a corresponding sensing signal.

16. The reading apparatus as claimed in claim 9, wherein the data transmission interface includes a universal serial bus transmission interface, a Bluetooth transmission interface and an infrared-ray transmission interface.

17. A method for controlling a reading apparatus, having a touch control screen, comprises:
detecting whether or not the reading apparatus linking with a mobile apparatus through a data transmission interface;
obtaining a display image from the mobile apparatus, when the reading apparatus linking with the mobile apparatus through the data transmission interface, wherein the display image is shown on a screen of the mobile apparatus originally;
showing the display image on the screen of the reading apparatus; and
generating a corresponding sensing signal, when an operation motion is performed on the touch control screen, so that the mobile apparatus determine whether or not responding to the operation motion.

18. A method for controlling a mobile apparatus, comprising:
detecting whether or not the mobile apparatus linking with a reading apparatus through a data transmission interface, wherein the reading apparatus has a touch control screen;
obtaining a mastership of the reading apparatus, when the mobile apparatus links with the reading apparatus through the data transmission interface;
transmitting a display image, which is shown on a screen of the mobile apparatus originally, to the reading apparatus through the data transmission interface, so as to show the display image on the screen of the reading apparatus;
detecting whether or not the reading apparatus generating a corresponding sensing signal resulted from an operation motion on the touch control screen being performed; and
obtaining the sensing signal, when an operation motion is performed on the touch control screen, so that the mobile apparatus determines whether or not responding to the operation motion.
